(19) United States
(12) Patent Application Publication
(10) Pub. No.: US 2019/0087881 A1
(43) Pub. Date: Mar. 21, 2019

(54) SYSTEM AND METHOD FOR PREDICTIVE QUOTING

(71) Applicant: LEAP GROUP INC., Toronto (CA)

(72) Inventor: Jeremy CHAPMAN, Austin, TX (US)

(21) Appl. No.: 16/044,961

(22) Filed: Jul. 25, 2018

Related U.S. Application Data
(60) Provisional application No. 62/560,125, filed on Sep. 18, 2017.

(51) Int. Cl. G06Q 30/06; G06Q 10/08; G06Q 50/04

(52) U.S. Cl. CPC G06Q 30/0611; G06Q 50/04; G06Q 10/0875

(57) ABSTRACT

A method and system for predictive quoting are provided. A first request is received, and includes at least one subset of attributes, each corresponding to one of a set of good types. The request is parsed to identify the at least one subset of attributes at least partially based on attribute set rules. Each of the at least one subset of attributes is parsed at least partially based on the attribute set rules to identify each of the attributes in the subset. For each of the at least one subset of attributes, at least one of the set of good types that the subset of attributes corresponds to is selected based at least partially on similarities between the subset of attributes and at least one expected pattern of attributes for each of the set of good types. At least one of a confirmation and a rejection of the predicted good type for each of the at least one subset of the attributes by a user is registered. The set of good types each of the at least one subset of attributes corresponds to is predicted for subsequent requests based at least partially on previously registered confirmations and rejections.

### CROSS-REFERENCE TO RELATED APPLICATIONS

This application claims the benefit of U.S. Provisional Application No. 62/560,125, filed Sep. 18, 2017, the contents of which are incorporated herein by reference in their entirety.

### FIELD

The specification relates generally to artificial intelligence systems. In particular, the following relates to a system and method for predictive quoting.

### BACKGROUND OF THE DISCLOSURE

In some industries, there are a wide variety of manners in which different materials and components are described. Procurers can have different contexts and experience, can be from multiple industries and sizes, representing small fabrication businesses to large engineering, procurement, construction and manufacturing corporations. These buyers may be interested in purchasing raw, semi-finished, or finished industrial materials and/or components, such as, for example, metal components, on a frequent basis, to build a product for end-user clients. Traditionally, in order to purchase these semi-finished industrial materials and parts, the buyers contact one or more distributors. The distributors can stock or have access to materials and parts via a variety of means. For example, the distributors can incorporate fabrication into their business as well as service centers and mills which produce the semi-finished industrial materials. In addition, the distributors can resell materials and/or components, sold by other companies. During the procurement process, buyers send one or more distributors requests-for-quotation (“RFQs”) that include lists of materials and/or components. This is typically done via a voice telephone call, fax, or email. These lists include one or more types of materials and/or components required, typically separated on separate lines. For each type of material or component, a description is provided for the material or component that includes some type of identifier of the material or component, and often includes a requested quantity, a desired delivery date, and potential quality standards required of the material in demand.

Procurers can request materials and/or components in a variety of manners. For example, one procurer may specify that they are looking for “Rnd 5×4”×20′ 4140×4″, where they are looking for four pipes that have a five inch outside diameter, a four inch inside diameter, 20 feet in length, and of a 4140 grade. In contrast, another procurer may specify “4×5×1×240” to indicate the same general requirement (without specification of the grade). Distributors must digest what the buyer is requesting, search a database of available materials and/or components, and find suitable materials and/or components to supply as a solution while providing a best price, a best delivery date, and a best quality of materials and/or components, and finally prepare a quote in order to secure the purchase order. Some of the items quoted and/or sold are similar to the item being requested and likely suitable for customer's application. A typical salesperson at a distributor will receive 100 in inquiry items per day, and a typical distribution company has 5-50 salespeople in each location.

Similarly, distributors receive lists of materials and/or components provided by suppliers, whether internal or external, and whether the materials and/or components are being received or the lists simply represent price lists of available materials and/or components. Similar to the lists provided with RFQs, these lists include one or more types of materials and/or components supplied, typically separated on separate lines. For each type of material or component, a description is provided for the material or component that includes some type of identifier of the material or component, a price, a quality standard, and often includes a quantity available or provided, a delivery date or lead time. These lists are typically entered into a database system that is structured in a particular manner, so that the supplier lists must be interpreted by an operator in order to populate the database in a consistent manner so that the database of available materials and/or components can be readily searched. The database systems are typically written in an archaic language such as Cobol and executed on an IBM AS/400 server that is not user friendly and do not readily enable data exchange with other applications.

The entering in of these lists from suppliers into the database and then the interpretation of the RFQ lists performed by operators is labour-intensive, costly, and slow. Further, the experience gained by an operator is generally not passed on to other operators. As a result, each operator spends time learning what was already learned by other operators.

### SUMMARY OF THE DISCLOSURE

In one aspect, there is provided a method for predictive quoting, comprising:

receiving a first request, via a computer system, including at least one subset of attributes, each of the at least one subset of attributes corresponding to one of a set of good types;

parsing the request to identify the at least one subset of attributes at least partially based on attribute set rules stored in storage of the computer system;

parsing each of the at least one subset of attributes at least partially based on the attribute set rules to identify each of the attributes in the subset;

selecting, for each of the at least one subset of attributes, at least one of the set of good types that the subset of attributes corresponds to based at least partially on similarities between the subset of attributes and at least one expected pattern of attributes for each of the set of good types stored in the storage of the computer system;

registering at least one of a confirmation and a rejection of the predicted good type for each of the at least one subset of the attributes by a user; and

predicting, by the computer system, which of the set of good types each of the at least one subset of attributes corresponds to for subsequent requests based at least partially on previously registered confirmations and rejections for the at least one subset of attributes and the selected good types.

The at least one subset of attributes can include at least two subsets of attributes. Each of the at least two subsets of attributes can include an ordered subset of attributes.

The method can further comprise:

performing a first query of a supply database to select a first subset of supply records corresponding with the selected good type for each of the at least two subsets of attributes;

performing a second query of the supply database to select a second subset of supply records for the selected good type using a set of alternative satisfaction rules for each of the at least two subsets of attributes when the first subset of supply records is empty; and

generating a user interface presenting the first subset and the second subset of supply records.

The parsing of each of the at least two subsets of attributes can comprise using a set of attribute parsing rules stored by the computer system that specify how to identify attributes.

The method can further comprise:

receiving a list of supplied resources, via a computer system, including at least two subsets of attributes;

parsing the list of supplied resources to identify the at least two subsets of attributes;

parsing each of the at least two subsets of attributes to identify each of the attributes in the subsets;

selecting, for each of the at least two subsets of attributes, by the computer system, one of the set of good types the subset of attributes corresponds to based at least partially on similarities between the subset of attributes and a set of attributes for each of the set of good types;

registering at least one of an acceptance and a rejection of the predicted good type for each of the at least two subsets of the attributes by a user;

predicting, by the computer system, which of the set of good types each of the at least two subsets of attributes corresponds to for subsequent requests based at least partially on previously registered confirmations and rejections for the at least two subsets of attributes and the selected good types; and

populating a supply database with the accepted good type for each of the at least two subsets of attributes.

In another aspect, there is provided a method for predictive quoting, comprising:

receiving requests, via a computer system, each of the requests including at least one subset of attributes;

parsing each of the requests to identify the at least one subset of attributes;

selecting, for each of the subsets of attributes, by the computer system, one of a set of good types the subset of attributes corresponds to based at least partially on similarities between the subset of attributes and a set of attributes for each of the set of good types;

registering at least one of an acceptance and a rejection of the predicted good type for each of the at least one subset of the attributes by a user; and

training, by the computer system, which of the set of good types each of the at least one subset of attributes corresponds to using the registered acceptance or rejection.

Each of the at least one subset of attributes can comprise an ordered subset of attributes.

According to a further aspect, there is provided a computer system, comprising:

at least one processor;

a storage storing supply data, attribute set rules, quote satisfaction rules, attribute string delimiters, attribute delimiters, expected patterns of attributes for good types, and computer executable instructions that, when executed by the at least one processor, cause the at least one processor to:

receive a first request including at least one subset of attributes, each of the at least one subset of attributes corresponding to one of a set of good types;

parse the request to identify the at least one subset of attributes at least partially based on the attribute set rules;

parse each of the at least one subset of attributes at least partially based on the attribute set rules to identify each of the attributes in the subset;

select, for each of the at least one subset of attributes, at least one of the set of good types that the subset of attributes corresponds to based at least partially on similarities between the subset of attributes and at least one expected pattern of attributes for each of the set of good types;

register at least one of a confirmation and a rejection of the predicted good type for each of the at least one subset of the attributes by a user; and

predict, by the computer system, which of the set of good types each of the at least one subset of attributes corresponds to for subsequent requests based at least partially on previously registered confirmations and rejections for the at least one subset of attributes and the selected good types.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 shows a computer system for predictive quoting in accordance with one embodiment thereof;

FIG. 2 is a schematic diagram showing various logical components stored in the database of the computer system of FIG. 1;

FIG. 3 is a flowchart of the general method of predictive quoting using the computer system of FIG. 1;

FIG. 4 is a flowchart of the general method of populating and/or updating the supply data in the predictive quoting method of FIG. 3;

FIG. 5 shows a portion of an email window presenting an email that has an RFQ list embedded in its email body;

FIG. 6 shows a search text field presented by the computer system of FIG. 1 into which an RFQ list is entered; and

FIG. 7 shows search results for the RFQ list generated by the computer system of FIG. 1.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

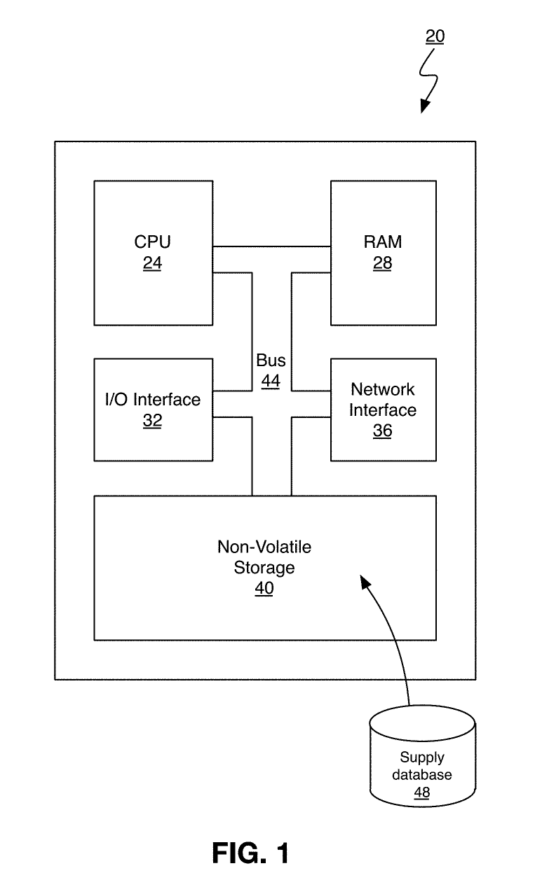

A computer system 20 for predictive quoting in accordance with an embodiment is shown in FIG. 1. Computer system 20 parses an unstandardized RFQ list using libraries of component and/or material descriptions and recognized patterns to predict what materials and/or components are being requested, and learns from the interaction of the user to make future predictions. Further, computer system 20 an unstandardized supply list using the libraries of components and/or part descriptions and recognized patterns to predict what materials and/or components are being supplied, and learns from the interaction of the user to make future predictions. Computer system 20 queries a supply database of the supplied materials and/or components to prepare a quote for requested components and/or materials.

Computer system 20 is an enterprise-grade server computer that is operated by a distributor at a central location. It has a web interface for enabling a number of users to access the functionality provided via a web browser on a computing device, such as a personal computer, a tablet, etc. Any computing device that communicates with computer system 20 to access the functionality provided by it may be referred to hereinafter as a client computing device. Computer system 20 is coupled to a computer network, which can be a private network, such as a local area network, and to a public network, such as the Internet, to enable client computing devices to connect to computer system 20 and access the functionality provided. In other embodiments, computer system 20 may only be accessible via a private network.

FIG. 1 shows various physical elements of computer system 20. As shown, computer system 20 has a number of physical and logical components, including a central processing unit (“CPU”) 24, random access memory (“RAM”) 28, an input/output (“I/O”) interface 32, a network interface 36, non-volatile storage 40, and a local bus 44 enabling CPU 24 to communicate with the other components. CPU 24 executes at least an operating system, a web service, a database service, and a predictive quoting software system. RAM 28 provides relatively responsive volatile storage to CPU 24. I/O interface 32 allows for input to be received from one or more devices, such as a keyboard, a mouse, etc., and outputs information to output devices, such as a display and/or speakers. Network interface 36 permits communication with other computing devices over computer networks such as a local computer network and/or the Internet. Non-volatile storage 40 stores the operating system, the web service, the database service, and programs, including computer-executable instructions for implementing the predictive quoting software system. During operation of computer system 20, the operating system, the services, the programs and data used by these may be retrieved from non-volatile storage 40 and placed in RAM 28 to facilitate execution.

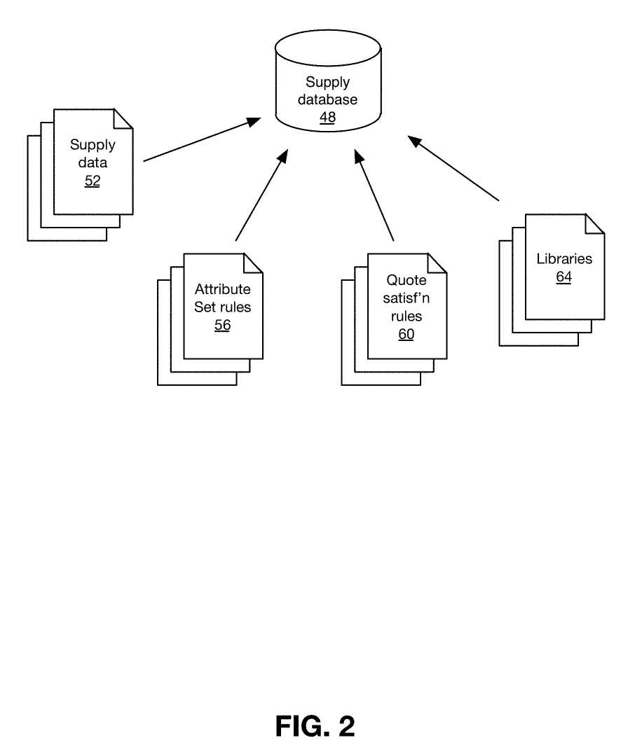

FIG. 2 shows various logical components stored within the database 48. In particular, database 48 stores supply data 52 that represents materials and/or components that are in stock or otherwise available to a distributor. A material and/or component may be referred to hereinafter interchangeably as a good. Supply data 52 includes records for each type of good available through the distributor. Each record for a good type can identify the supplier, the location of the good, the type of good, including the material and/or component name, the dimensions, the characteristics, the quality, the quantity or amount, the lead time for goods currently not in stock for delivery, etc.

A set of attribute set rules 56 define the logic used to parse attribute strings representing sets of attributes from one another, each of the sets of attributes corresponding to one of a set of good types, attributes within the strings from one another, and to interpret what each attribute in a string for a good means. The attribute set rules 56 can use patterns to analyze strings to determine what is likely an attribute string delimiter and what is likely an attribute delimiter. Further, the patterns can be used to analyze characters, control codes, etc. in relation to adjacent characters, control codes, etc. in order to interpret them.

A set of quote satisfaction rules 60 are used to determine how to filter the supply data based on normalized RFQ list data, and how to locate alternative supplied goods where an exact match cannot be located. The quote satisfaction rules 60 can define scoring for matching between a set of attributes and at least one expected pattern of attributes for a good type. In an alternative embodiment, the quote satisfaction rules can at least partially eliminate good types based on a decision tree.

Libraries 64 stored in supply database 48 store sets of attributes for a plurality of good types. In addition, the libraries 64 maintain scores for use by computer system 20 to predictively select a good type, as will be discussed below. Separate libraries are maintained for procurers, distributors and service centers, and mills, as each of these types of people can have distinct manners of describing goods, and, accordingly, it can be beneficial to maintain separate libraries so at least that the scores accumulated for procurers, distributors, and mills don't cross-pollenate. In addition, the libraries 64 include attribute string delimiters and attribute delimiters. Attribute string delimiters are characters, control codes, etc. that are used to separate sets of attributes corresponding to good types from one another. For example, attribute string delimiters can include a hard return, a semi-colon, etc. Where data is being retrieved from a non-plain text source, other delimiters can be used, such as cell delimiters for a spreadsheet. Attribute delimiters are characters, control codes, etc. that are used to separate attributes within sets of attributes in attribute strings from one another. Examples of attribute delimiters can include spaces, commas, hyphens, etc. The libraries 64 also include patterns used to analyze strings to determine what is likely an attribute string delimiter and what is likely an attribute delimiter. Further, the patterns can be used to analyze characters, control codes, etc. in relation to adjacent characters, control codes, etc. in order to interpret them.

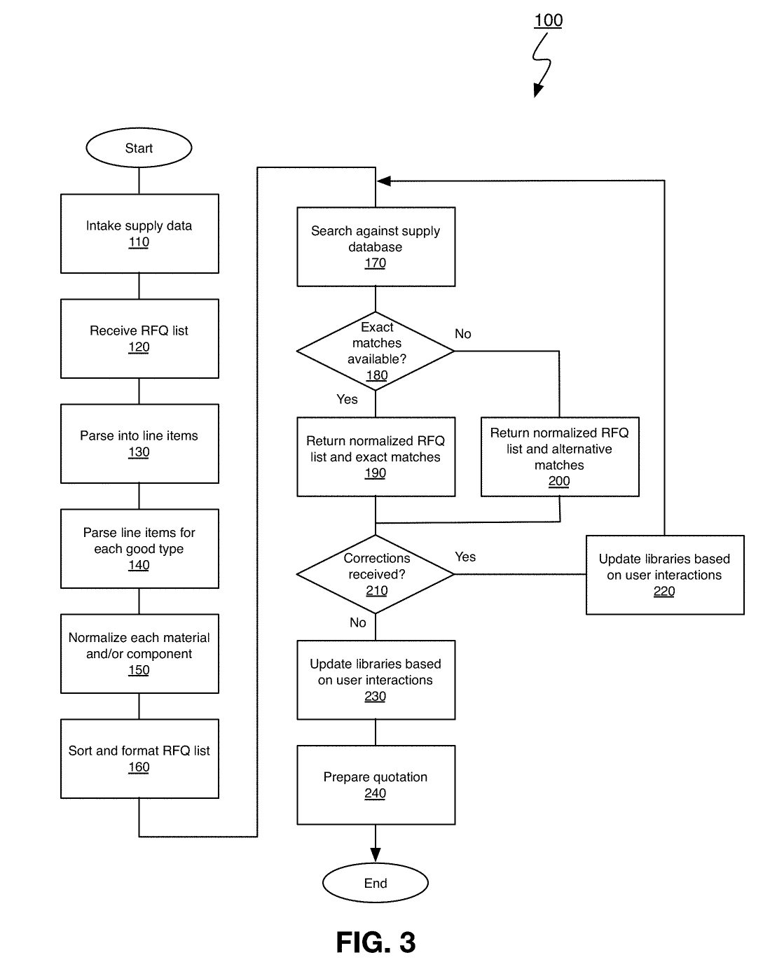

The method 100 of predictive quoting carried out by computer system 20 will now be discussed with reference to FIGS. 1 to 3. Method 100 commences with the intake of supply data (110).

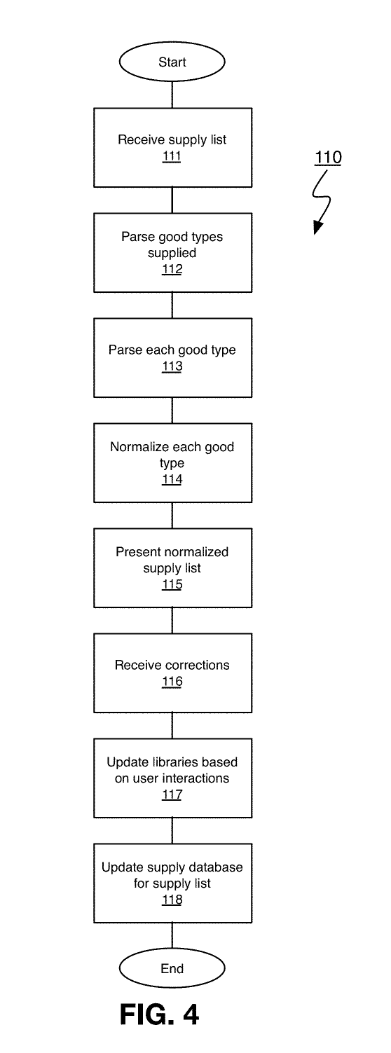

FIG. 4 shows the process of intake of supply data in greater detail. A supply list is received (111). A supply list is a list of goods that is either being received and stocked, or is otherwise being made available to the distributor. It can be a single line string, a set of strings separated by hard returns, etc. In the current implementation, the supply list is received via a text entry field in a web page generated by computer system 20. This can be achieved by typing it in or pasting it in from elsewhere, such as an email, etc.

The supply list is parsed to identify goods (112). Typically, good types are separated in a standardized manner. Attribute string separators forming part of the attribute set rules 56 identify various standard separators for strings relating to a good type. For example, good types can be separated in the supply list by hard returns. Alternatively, another convention can be employed to separate them, such as semicolons.

Upon separation of the supply list for each good type, the data for each good type is parsed (113). Computer system 20 uses the attribute separators forming part of the attribute set rules 56 to parse the string of characters relating to a good type to determine what characters represent attributes and what characters represent delimiters, etc.

Once the attributes for each good type are parsed, the data for each good type is normalized (114). As mentioned, each supplier may use a different convention to refer to the same material or component. Below in Table 1 are a set of exemplary descriptions that may be provided in the RFQ list and a translation of what is meant by each. All of the descriptions provided below refer to the same component.

TABLE 1
Description variations

| | Translation | | | | |
|---|---|---|---|---|---|
| | | Outside | Inside | | |
| Description | Shape | Diameter | Diameter | Grade | Length |
| Rnd 5 × 4″ × | round tube | 5 | 4 | 4140 | 20 |
| 20′ 4140 | | | | | |
| | | Nominal | | | |
| Description | Shape | Pipe Size | Schedule | Grade | Length |
| 5 × 120 × h × | round tube | 5 | 120 × H | 4140 | 20 |
| 240″ | | | | | |
| | | Outside | | | |
| Description | Shape | Diameter | Pound/Ft | Grade | Length |
| 5′/23.20# R2 | round tube | 5 | 23.2 | 4140 | 20 Feet |
| 5/23.20 @ 20′ | round tube | 5 | 23.2 | 4140 | 20 Feet |
| 5/23.20 × 20 | round tube | 5 | 23.2 | 4140 | 20 Feet |
| | | Outside | Wall | | |
| Description | Shape | Diameter | Thickness | Grade | Length |
| 5-0.5-240-Tube | round tube | 5 | ½ | 4140 | 20 |
| HR | | | | | |

During normalization, computer system 20 compares the parsed attributes for a good type to the attributes for the good types stored in the libraries 64. In this embodiment, the libraries 64 are actively populated datasets of the attributes for each known good type. Computer system 20 locates the best guess in the supplier library of the libraries 64 using the major attributes of each good type.

Upon normalizing the supply list, it is presented in a user interface (i.e., on a web page) to the user entering the supply list (115).

Corrections can then be received from the user via the user interface (116). The user can interact with the user interface to correct any attribute interpreted from the supply list and/or to select a different good type.

The scores in the supplier library of the libraries 56 are then updated based on the corrections or acceptances made by the user (117). If the user accepts the predicted good type, then a score for the relationship between the parsed attributes from the supply list and the predicted good type is incremented. If, instead, the user corrects the predicted good type, then a score for the relationship between the parsed attributes from the supply list and the predicted good type is decremented. These increments and decrements are used to affect future predictions by computer system 20 in selecting a good type based on a set of attributes.

Once the supply list has been mapped to good types via user interaction, computer system 20 registers the identified supplied good types and any relevant data, such as location, lead time, cost, units, volume, etc. in supply database 48.

It will be appreciated that additional or revised supply data can be provided at any time to update supply data 52 stored in supply database 48.

Returning again to FIGS. 1 to 3, once the supply data is intaken, an RFQ list is received by computer system 20 (120). RFQ lists can be received by the distributor in many different ways. RFQ lists can come in the form of a spreadsheet document, a fax, an email, data communicated via a phone call, etc.

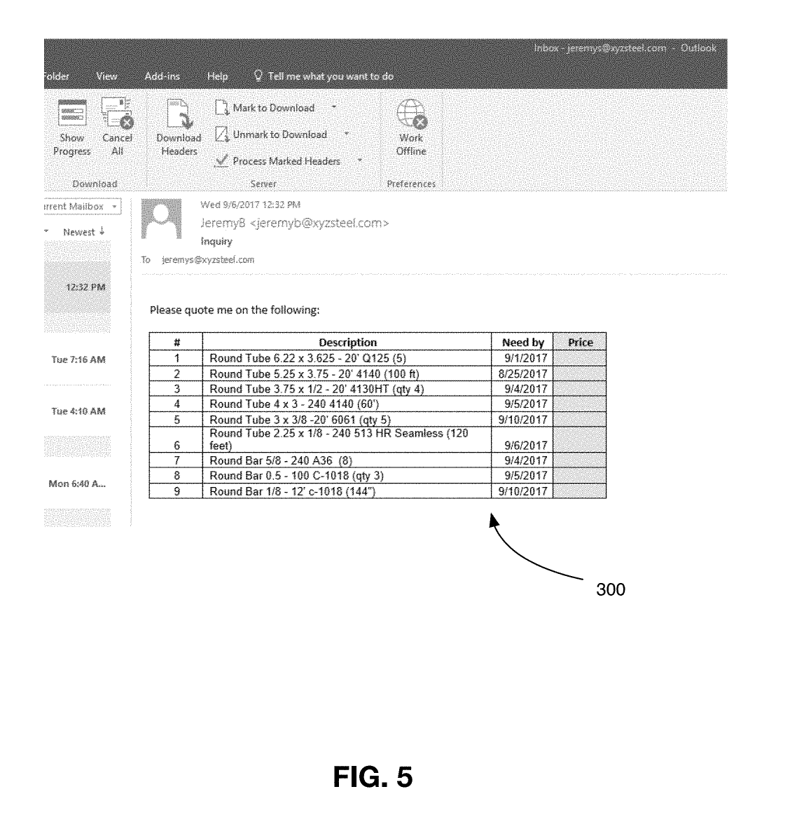

FIG. 5 shows an exemplary RFQ list 300 received in the body of an email. RFQ list 300 includes nine line items. Each of the line items includes a description and a need-by date.

The RFQ list is then entered into computer system 20 by copying and pasting, typing, uploading a text file, etc.

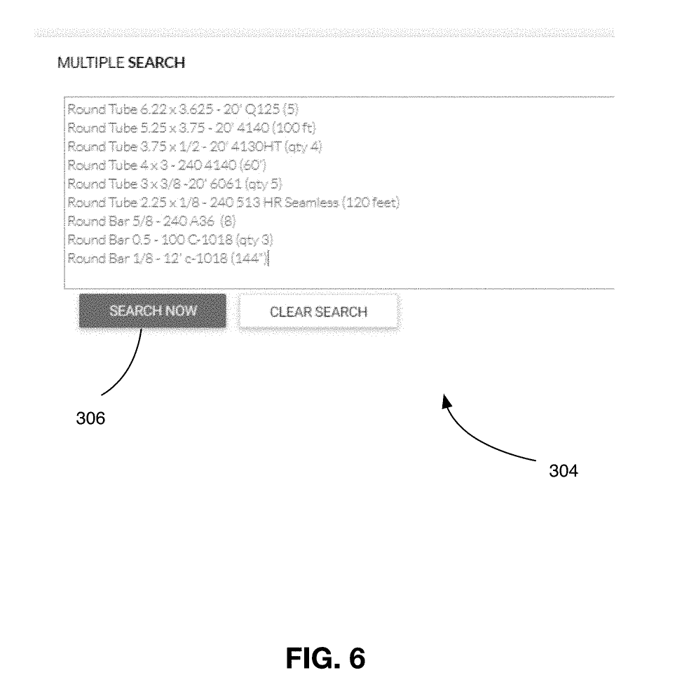

FIG. 6 shows a portion of the user interface 304 generated by the predictive quoting software system executing on computer system 20, wherein a user has entered the RFQ list into a text field. A search button 306 causes the predictive quoting software system to commence processing and searching of the requested goods.

Returning again to FIGS. 1 to 3, the RFQ list is parsed into line items (130). Typically, good types are separated in a standardized manner. For example, strings relating to each good type can be separated in the RFQ list by hard returns to create line items. Alternatively, another convention can be employed to separate them.

Upon separation of the RFQ list for each good, the data for each good is parsed (140). Computer system 20 uses the attribute set rules 56 to parse the string of characters to determine what characters represent attributes and what characters represent delimiters, etc.

Once the data for each good is parsed, the data is normalized (150). As mentioned, each procurer may use a different convention to refer to the same material or component. This step is generally the same as for 114 described above and in Table 1. During normalization, computer system 20 compares the parsed attributes for a good type to the attributes for the good types stored in the procurer library of the libraries 64. In this embodiment, the libraries 64 are actively populated datasets of the attributes for each known good type. Computer system 20 locates the best guess in the libraries 64 using the major attributes of each good type.

Upon normalizing the RFQ list, the list is sorted and formatted (160). Each procurer can request a quotation in a particular sorted order, and in a particular format. For example, one procurer may wish quantity to be expressed as the last attribute for a good, whereas another may wish it to be the first attribute. Further, different procurers can specify different formats for expressing attributes of a material or component; e.g., feet may be expressed via “′” or “ft”, plate may be expressed as “plate,” “plt”, “sheet”, etc.

The sorted, formatted, normalized RFQ list is then queried against the supply database (170). In searching for each line item in the RFQ list, the predictive quoting software system queries the supply database 48 to locate matches for the requested goods.

It is then determined if the query of supply database 48 locates available goods that satisfy the RFQ list (180). If it is determined at 180 that the query locates available goods in supply database 48 for the query, the predictive quoting software system generates a web page with the list of the sorted and formatted RFQ list, together with the available supplies for each requested good type (190).

If, instead, it is determined at 180 that the search does not locate available goods that satisfy the query, the predictive quoting software system uses quote satisfaction rules 60 to generate alternative queries that are executed against supply database 48. System appends logic from quote satisfaction rules 60 to buyer inquiry to incorporate alternate acceptable solutions.

Example 1: procurer wants quantity 4 of a component with length 20′; system searches for inventory>=20 but searches for 20′ first and 40′ second b/c 40′ can be cut in half.

Example 2: buyer wants plate/sheet with abnormal width length

Example 3: 120″ plt 24″ 3/4″ ; system searches where shape=plate, thickness or gauge=3/4″, width>=24, length>=120″

Example 4: tube 6.18×3.64; system searches for exact match but then sorts by OD>=6.18 and then ID<=3.64 or WT>=1.27

Upon receipt of the results of the alternative queries, the predictive quoting software system generates a web page with the list of the sorted and formatted RFQ list, together with the available supplies for each requested good type generated via the alternative queries (200). It should be noted that none, some, or all of the requested good types may require an alternative query be run against supply database 48, in which case the results from 190 and 200 can be combined.

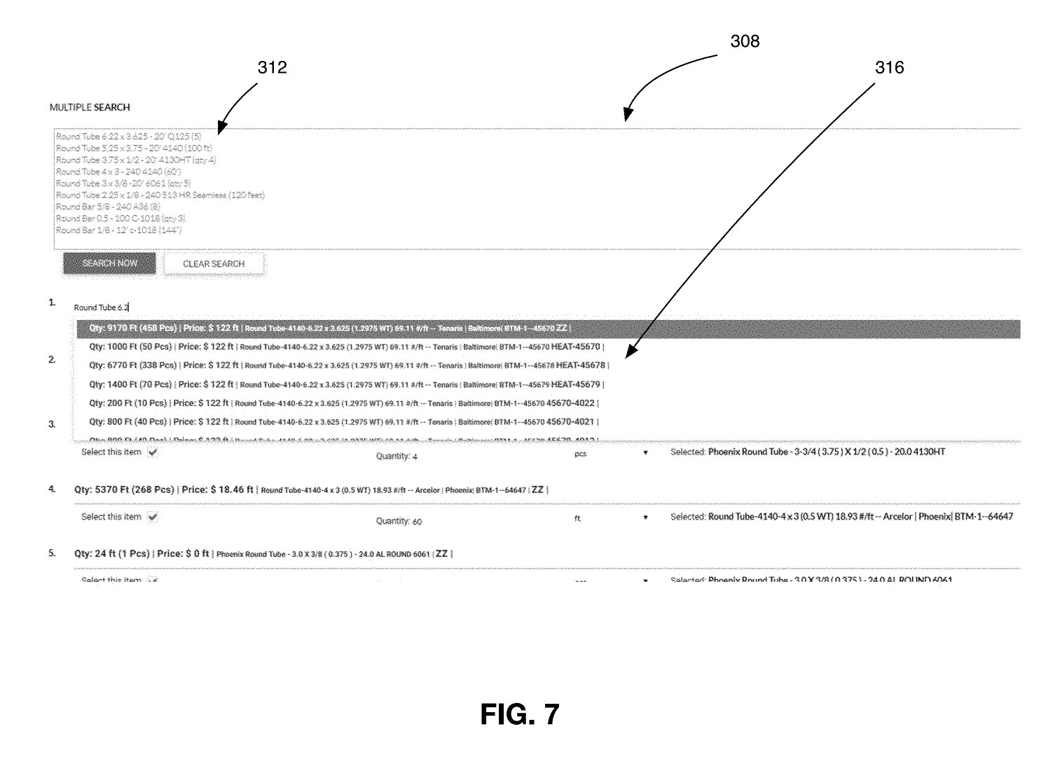

FIG. 7 shows a portion of a webpage 308 generated by the predictive quoting software system wherein the RFQ list has been entered in a text field 312, and a corresponding set of search results have been returned. A dropdown list 316 enables a user to select alternative options for each good or to correct the type of good being requested.

Returning again to FIGS. 1 to 3, corrections are then received (210). A user can interact with the web page showing the requested goods and the search results to accept or correct any of the data thereon. The user may correct the parsing of the requested goods from the RFQ list, and the normalization, and may accept or reject the search results (or select options within the search results to generate a quote). If the user corrects an attribute of a requested good, the score for the association between the received line item and the parsed attributes is scored to reflect the correction. If the user corrects the identification of a good type in supply database 48, the score for the association between the received and parsed attributes and the good type is reduced. If alternative query results are returned and rejected by the user, the score for the corresponding quote satisfaction rule is adjusted. This is done either at 220 when rerunning a query against supply database 48, or at 230 after it's been determined that no further queries need to be run.

Finally, if query results have been accepted by the user, the predictive quoting software system generates a quote based on the accepted search results (240). This entails

Computer system 20 can be exposed directly to procurers and suppliers, and can be integrated with other systems that these parties may have.

In an alternative embodiment, the supply lists and the RFQ lists can be received in other formats. For example, spreadsheets can be provided instead of straight text. In another implementation, a CAD model can be provided and parsed to identify required materials. The requests can take other forms, such as a project definition, a product definition, etc.

While, in the above-described embodiment, metal parts are used to illustrate its working, the system can be used for other types of goods, such as raw materials like powdered materials, chemicals, etc. Further, the system can be used to match requests for other types of resources, such as temporary workers.

Computer-executable instructions for implementing the predictive quoting software system on a computer system could be provided separately from the computer system, for example, on a computer-readable medium (such as, for example, an optical disk, a hard disk, a USB drive or a media card) or by making them available for downloading over a communications network, such as the Internet.

While the computer system is shown as a single physical computer, it will be appreciated that the computer system can include two or more physical computers in communication with each other. Accordingly, while the embodiment shows the various components of the computer system residing on the same physical computer, those skilled in the art will appreciate that the components can reside on separate physical computers.

Persons skilled in the art will appreciate that there are yet more alternative implementations and modifications possible, and that the above examples are only illustrations of one or more implementations. The scope, therefore, is only to be limited by the claims appended hereto.

1. A method for predictive quoting, comprising:
receiving a first request, via a computer system, including at least one subset of attributes, each of the at least one subset of attributes corresponding to one of a set of good types;
parsing the request to identify the at least one subset of attributes at least partially based on attribute set rules stored in storage of the computer system;
parsing each of the at least one subset of attributes at least partially based on the attribute set rules to identify each of the attributes in the subset;
selecting, for each of the at least one subset of attributes, at least one of the set of good types that the subset of attributes corresponds to based at least partially on similarities between the subset of attributes and at least one expected pattern of attributes for each of the set of good types stored in the storage of the computer system;
registering at least one of a confirmation and a rejection of the predicted good type for each of the at least one subset of the attributes by a user; and
predicting, by the computer system, which of the set of good types each of the at least one subset of attributes corresponds to for subsequent requests based at least partially on previously registered confirmations and rejections for the at least one subset of attributes and the selected good types.

2. A method according to claim 1, wherein the at least one subset of attributes comprises at least two subsets of attributes.

3. A method according to claim 2, wherein each of the at least two subsets of attributes comprises an ordered subset of attributes.

4. A method according to claim 3, further comprising:
performing a first query of a supply database to select a first subset of supply records corresponding with the selected good type for each of the at least two subsets of attributes;
performing a second query of the supply database to select a second subset of supply records for the selected good type using a set of alternative satisfaction rules for each of the at least two subsets of attributes when the first subset of supply records is empty; and
generating a user interface presenting the first subset and the second subset of supply records.

5. A method according to claim 3, wherein the parsing of each of the at least two subsets of attributes comprises:
using a set of attribute set rules stored by the computer system that specify how to identify attributes.

6. A method according to claim 1, further comprising:
receiving a list of supplied resources, via a computer system, including at least two subsets of attributes;
parsing the list of supplied resources to identify the at least two subsets of attributes;
parsing each of the at least two subsets of attributes to identify each of the attributes in the subsets;
selecting, for each of the at least two subsets of attributes, by the computer system, one of the set of good types the subset of attributes corresponds to based at least partially on similarities between the subset of attributes and a set of attributes for each of the set of good types;
registering at least one of an acceptance and a rejection of the predicted good type for each of the at least two subsets of the attributes by a user;
predicting, by the computer system, which of the set of good types each of the at least two subsets of attributes corresponds to for subsequent requests based at least partially on previously registered confirmations and rejections for the at least two subsets of attributes and the selected good types; and
populating a supply database with the accepted good type for each of the at least two subsets of attributes.

7. A method for predictive quoting, comprising:
receiving requests, via a computer system, each of the requests including at least one subset of attributes, each of the at least one subset of attributes corresponding to one of a set of good types;
parsing each of the requests to identify the at least one subset of attributes at least partially based on attribute set rules stored in storage of the computer system;
parsing each of the at least one subset of attributes at least partially based on the attribute set rules to identify each of the attributes in the subset;
selecting, for each of the subsets of attributes, by the computer system, one of the set of good types the subset of attributes corresponds to based at least partially on similarities between the subset of attributes and a set of attributes for each of the set of good types stored in the storage of the computer system;
registering at least one of a confirmation and a rejection of the predicted good type for each of the at least one subset of attributes by a user; and
training, by the computer system, which of the set of good types each of the at least one subset of attributes corresponds to using the registered confirmation or rejection for the at least one subset of attributes and the selected good types.

8. A method according to claim 7, wherein each of the at least one subset of attributes comprises an ordered subset of attributes.

9. A computer system, comprising:
at least one processor;
a storage storing supply data, attribute set rules, quote satisfaction rules, attribute string delimiters, attribute delimiters, expected patterns of attributes for good types, and computer executable instructions that, when executed by the at least one processor, cause the at least one processor to:
receive a first request including at least one subset of attributes, each of the at least one subset of attributes corresponding to one of a set of good types;
parse the request to identify the at least one subset of attributes at least partially based on the attribute set rules;
parse each of the at least one subset of attributes at least partially based on the attribute set rules to identify each of the attributes in the subset;
select, for each of the at least one subset of attributes, at least one of the set of good types that the subset of attributes corresponds to based at least partially on similarities between the subset of attributes and at least one expected pattern of attributes for each of the set of good types;
register at least one of a confirmation and a rejection of the predicted good type for each of the at least one subset of the attributes by a user; and
predict, by the computer system, which of the set of good types each of the at least one subset of attributes corresponds to for subsequent requests based at least partially on previously registered confirmations and rejections for the at least one subset of attributes and the selected good types.
